(19) United States
(12) Patent Application Publication
(10) Pub. No.: US 2017/0156301 A1
(43) Pub. Date: Jun. 8, 2017

(54) ADJUSTABLE TENSION KITE FISHING APPARATUS

(71) Applicants: Raymond A. Rosher, Miami, FL (US); Marvin J. Marshall, JR., Micco, FL (US)

(72) Inventors: Raymond A. Rosher, Miami, FL (US); Marvin J. Marshall, JR., Micco, FL (US)

(21) Appl. No.: 15/367,782

(22) Filed: Dec. 2, 2016

Related U.S. Application Data
(60) Provisional application No. 62/263,127, filed on Dec. 4, 2015.

(51) Int. Cl. A01K 91/06; A01K 97/00; F16M 13/02; B65H 57/10; B65H 57/06; F16B 2/06; A01K 99/00; B64C 31/06

(52) U.S. Cl. CPC A01K 91/06; A01K 99/00; A01K 97/00; B64C 31/06; B65H 57/10; B65H 57/06; F16B 2/065; F16M 13/022

(57) ABSTRACT

A kite fishing apparatus that aligns properly, is light weight, and is consistently adjustable by the user to their desired tension for smooth release of their fishing line when a fish strikes or when any force overcomes the applied tension placed on the fishing line holding ring. The device is advantageously light weight, in part due to lightweight materials used to construct the device without reducing the device's performance.

### CROSS-REFERENCE TO RELATED APPLICATION

This application claims the benefit of priority of U.S. provisional application No. 62/263,127, filed on Dec. 4, 2015, the contents of which are herein incorporated by reference.

### BACKGROUND OF THE INVENTION

The present invention relates to kite-fishing and, more particularly, to an improved apparatus for optimizing the kite fishing technique.

Kite fishing is a popular sport for catching large predatory fish, such as sailfish, kingfish, dolphin, marlin, bass, and various other types of fish in a body of water such as an ocean or a river. This technique keeps the bait away from the noise of the fishing vessel and close to the waters' surface, where the bait splashes the surface of the water, thus attracting target fish.

In prior inventions, the angle of the kite fishing line in relation to the release arm or fishing line holding ring is not aligned for optimal performance. This less than optimal angle combined with the small diameter of the fishing line wire creates unnecessary stress and friction on the fishing line. Due to these problems, fishing lines tend to tangle on, break, or not release smoothly from the release arm or the holding ring. Further, the specific tension needed for the fishing line to release is not adjustable to an extent that is sufficient, precise or consistent enough to facilitate optimal uses in the varying kite fishing techniques.

The overall weight of prior devices also has an adverse effect on the varying kite fishing techniques, for example, during light wind conditions where weight is critical to proper fishing kite flight, and where multiple fishing line release devices are attached to a single kite line, which is attached to a single kite.

As can be seen, there is a need for a device which is light weight and allows proper alignment and consistently adjustable tension of the kite fishing line.

### SUMMARY OF THE INVENTION

The present invention relates to a kite fishing apparatus that aligns properly, is light weight, and is consistently adjustable by the user to their desired tension for smooth release of their fishing line when a fish strikes or when any force overcomes the applied tension placed on the fishing line holding ring. The device is advantageously light weight, in part due to lightweight materials used to construct the device without reducing the device's performance.

In one embodiment, the device includes a kite fishing apparatus comprising an apparatus body, an adjustable thumb screw coupled to the apparatus body, and a ring gripping mechanism on a distal end of the apparatus body. The ring gripping mechanism holds a releasable ring. The ring gripping mechanism can increase or decrease a tension on the ring when the adjustment screw is tightened or loosened. The adjustable screw can be screwed into a female portion on the apparatus.

The apparatus may further include a beveled entry and exit at a proximal end of the apparatus body, wherein a kite fishing line can be run through an aperture of the beveled entry and exit.

In one embodiment, the ring gripping mechanism comprises a flexible fishing line ring gripper and a fishing line holding ring pad, wherein the ring is positioned between the ring gripper and the ring pad. A free moving fishing line is run through the ring. The ring and fishing line are aligned perpendicular to the kite fishing line. The ring is adapted to be releasable whenever a necessary tension is applied to the ring by the fishing line. In one embodiment, the ring can release into the water once a fish applying the necessary force to overcome the tension on the ring, is caught.

These and other features, aspects and advantages of the present invention will become better understood with reference to the following drawings, description and claims.

### BRIEF DESCRIPTION OF THE DRAWINGS

FIG. 1 is a perspective view of the present invention shown in exemplary use;

FIG. 2 is a perspective view of the present invention shown with a ring attached;

FIG. 3 is a perspective view of the present invention shown with a ring detached;

FIG. 4 is a section view of the present invention taken along line 4-4 of FIG. 2 illustrated without the ring;

FIG. 5 is a perspective view of the present invention demonstrating exaggerated closing configuration;

FIG. 6 is a section detail view of the present invention illustrated without the ring and demonstrating a ring gripper in an exaggerated closing configuration; and

FIG. 7 is a section view of the present invention illustrating a ring and lines.

### DETAILED DESCRIPTION OF THE INVENTION

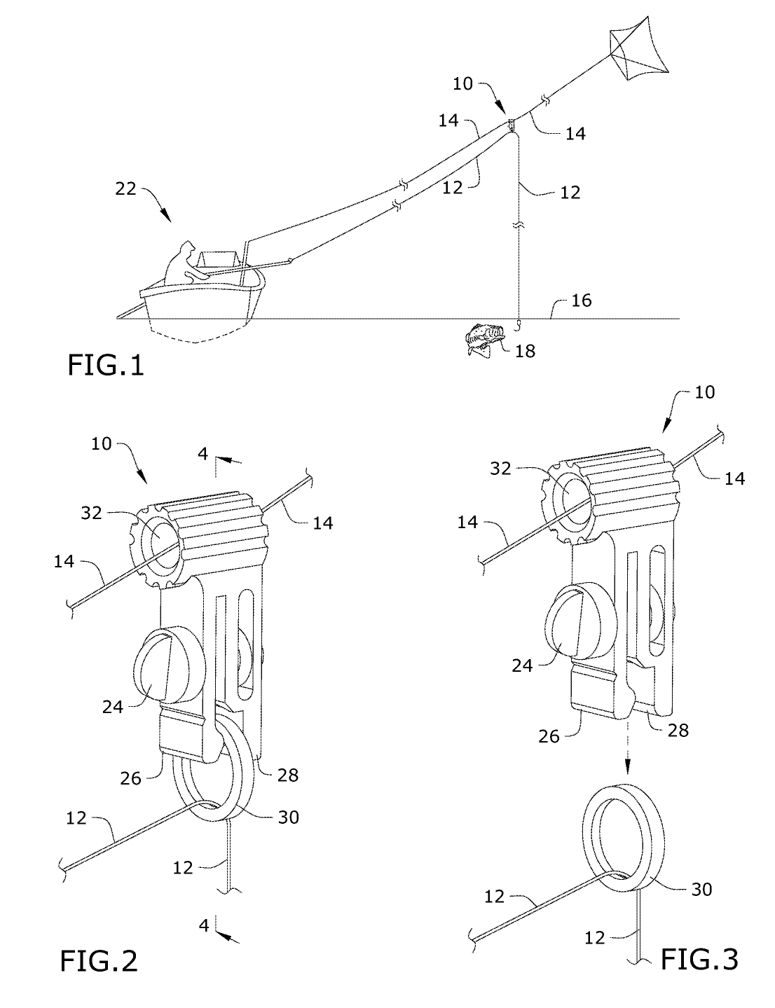

A description of preferred embodiments of the invention follows. In one embodiment as shown in FIG. 1, a kite fishing apparatus 10 (herein referred to as the “apparatus”) is attached to a kite line 14 and a fishing line 12. A kite is attached to the kite line 14 and provides the lift necessary to keep bait close to the to the surface of water body 16. The fishing line 12 is dropped below the water line 16 to bait a fish 18. When live bait is taken, the force releases the fishing line 12 from the apparatus 10 and the kite line 14. A fisherman 22 can then use a rod and reel to wind in the fishing line 12. More than one fishing line 12 can similarly be attached to one or more additional apparatuses 10, and kite line 14.

FIG. 2 is a perspective view of one embodiment of apparatus 10. Apparatus 10 includes a flexible fishing line ring gripper 26, a fishing line holding ring pad 28, a tension adjustment thumb screw 24, and beveled entry/exit 32. In one embodiment, the beveled entry/exit 32 can range in size from about 0.060 inches up to about 0.320 inches in diameter, though the sizes can vary. Advantageously, the beveled entry/exit can allow for placement of the appropriately sized hole for the varying size of stoppers used for multiple fishing line release apparatuses from a single kite line 14. In an alternative embodiment, the beveled exit/entry 32 can be modified to run outrigger halyard materials and downrigger cables in place of a standard kite line 12.

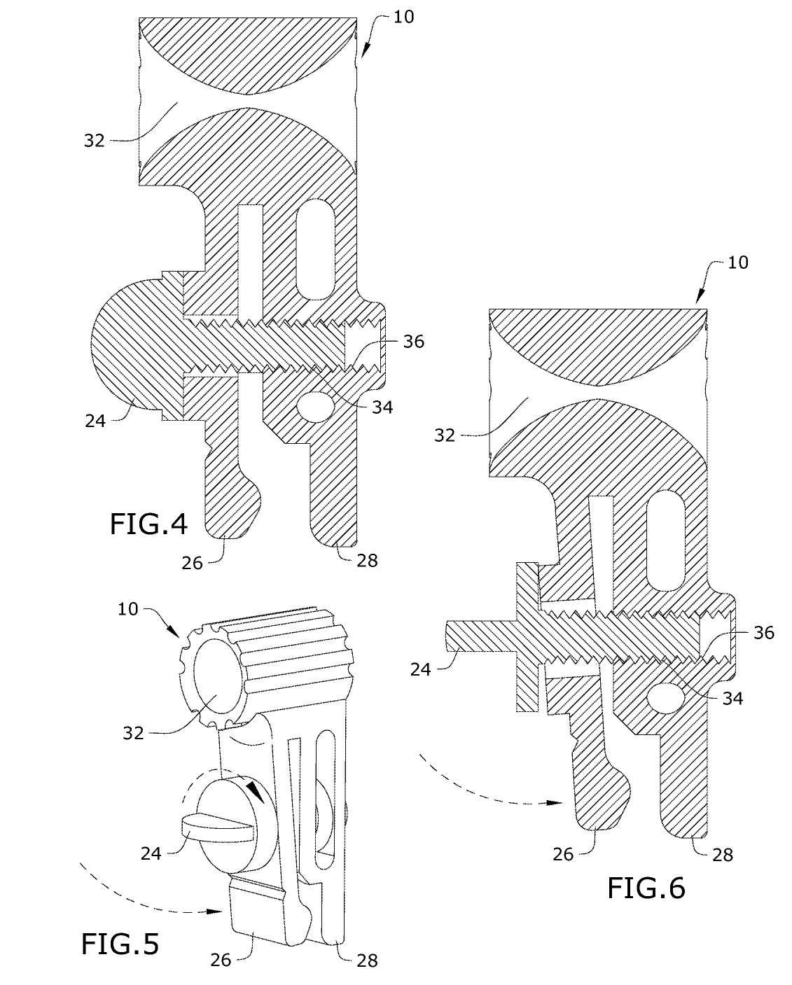

As shown in FIG. 4, the thumb screw 24 can be attached to apparatus 10 by positioning or screwing a male portion 34 of thumb screw 24 into a female thread 36 on the body of the apparatus 10. A ring 30 sits between gripper 26 and ring pad 28. Detached ring 30 is shown in FIG. 3. The positioning of lines 12 and 14 are shown in the sectional view of FIG. 7.

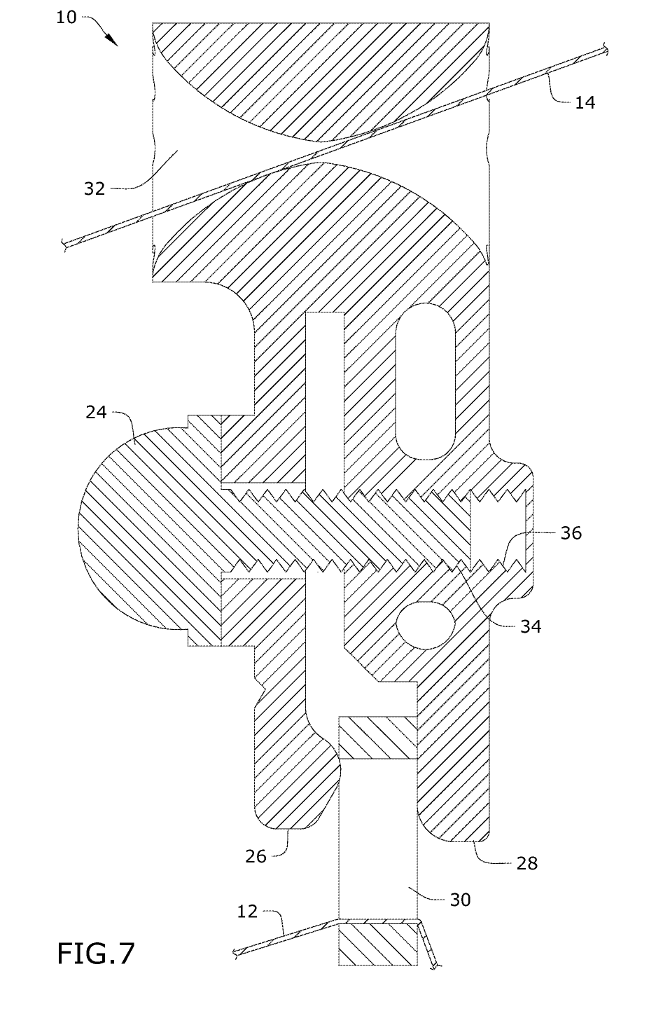

In one embodiment, fishing kite line 14 is run through the beveled entry/exit 32. This action can align the ring 30 perpendicular to the fishing kite line 14. As shown in FIG. 5 and in the section view of FIG. 6, when the thumb screw 24 is tightened, the distance between the gripper 24 and ring pad 28 decreases and places tension upon the ring 30, which contains fishing line 12. The tension can be adjusted as desired by the user. The applied tension constricts the ring 30, but allows the fishing line 12 to retain a free range of motion through the ring 30. As sufficient pressure to overcome the tension setting is applied through fishing line 12 (by a baited fish for example), the apparatus releases the ring 30, and hence, the user's fishing line 12 smoothly and consistently. The user can then reel the fishing line 12 in. Advantageously, apparatus 10 eliminates hanging up, or restriction of the fishing lines release, no matter what angle or direction the fishing line is pulled. Further, a rounded gripper surface of ring 30 creates reliable, smooth releases.

An experienced user can adjust the tension applied to the ring, and thus the force needed to overcome that tension based on the estimated force (or weight) of the desired fish/bait being used. In one embodiment, the tension can range from 0 to approximately 25 pounds or more of necessary force to cause the ring 30 to release from apparatus 10.

Advantageously, the apparatus can be used by both right and/or left-handed people. Further, the apparatus 10 is constructed of light-weight materials and the weight distribution of the apparatus' design makes the entire invention less likely to cause adverse stress on the fishing line or to tangle with the fishing line. In one embodiment, the weight of apparatus 10 is approximately half of the weight of prior kite fishing line release mechanisms.

While the prior embodiments are designed for kite fishing, it should be understood that it can also be used in several fishing techniques where one wants a controlled release of their fishing line from a remote location. The apparatus, for example, can be used with alternative offshore fishing devices such as outriggers, flat lines, or downrigger.

All said components of this invention can be made using several techniques, including but not limited to plastic injection molding, 3D printing, CNC machining, metal or plastic forming, stamping of various plastics or metals, or any other suitable method.

Further, the components of apparatus 10 can be made of several different materials or all the same material. In one embodiment, the components can be made of forged metals or sintering of various materials. In alternative embodiments, apparatus 10 can be made using snap plastic injection connections instead of traditional securing hardware, such as screw, nuts or rivets. In an alternative embodiment, components can be epoxied, glued, ultrasonically bonded, welded or attached by any suitable means.

It should be understood, of course, that the foregoing relates to exemplary embodiments of the invention and that modifications may be made without departing from the spirit and scope of the invention as set forth in the following claims.

What is claimed is:

1. A kite fishing apparatus comprising:
an apparatus body;
an adjustable thumb screw coupled to the apparatus body; and
a ring gripping mechanism at a distal end of the apparatus body, the ring gripping mechanism holding a releasable ring, and the ring gripping mechanism being able to increase or decrease a tension on the ring when the adjustment screw is tightened or loosened.

2. The device of claim 1, further comprising a beveled entry and exit at a proximal end of the apparatus body, wherein a kite fishing line can be run through an aperture of the beveled entry and exit.

3. The device of claim 1, wherein the adjustable screw is screwed into a female portion on the apparatus.

4. The device of claim 1 where the ring gripping mechanism comprises a flexible fishing line ring gripper and a fishing line holding ring pad, wherein the ring is positioned between the ring gripper and the ring pad.

5. The device of claim 1, wherein a fishing line is run through the ring.

6. A method of kite fishing comprising;
providing a kite fishing apparatus comprising:
an apparatus body;
an adjustable thumb screw coupled to the apparatus body; and
a ring gripping mechanism at a distal end of the apparatus body, the ring gripping mechanism holding a releasable ring;
running a fishing line through the releasable ring;
tightening the adjustment screw such that the ring gripping mechanism applies tension to said ring; and
increasing or decreasing the tension based on an estimated force desired to release said ring.

7. The method of claim 6, further comprising running a kite fishing line through an aperture of a beveled entry and exit at a proximal end of the apparatus body.

8. The method claim 6, wherein the fishing line, holding a bait or lure, is dropped in the water.

9. The method of claim 6, wherein the ring is released into the water once a fish with the necessary force to overcome the tension on the ring is caught.

10. The method of claim 6, wherein the releasable ring and fishing line are perpendicular to the kite line.
